(19) United States
(12) Patent Application Publication
(10) Pub. No.: US 2026/0036770 A1
(43) Pub. Date: Feb. 5, 2026

(54) OPTICAL DEVICE AND OPTICAL TRANSMITTING-RECEIVING MODULE

(71) Applicant: FUJITSU OPTICAL COMPONENTS LIMITED, Kawasaki-shi (JP)

(72) Inventors: Tsuyoshi AOKI, Machida (JP); Tamotsu AKASHI, Atsugi (JP); Nobuaki HATORI, Tsukuba (JP); Masanari YAMAKITA, Tama (JP); Yurika YANADA, Kawasaki (JP)

(73) Assignee: FUJITSU OPTICAL COMPONENTS LIMITED, Kawasaki-shi (JP)

(21) Appl. No.: 19/057,483

(22) Filed: Feb. 19, 2025

(30) Foreign Application Priority Data
Aug. 2, 2024 (JP) 2024-126488

(51) Int. Cl. G02B 6/42

(52) U.S. Cl. CPC G02B 6/4253; G02B 6/428

(57) ABSTRACT

An optical device includes a photonic integrated circuit chip and a resin member. The photonic integrated circuit chip has a first surface on which an optical circuit and first electrical wiring are formed. The resin member makes contact with at least part of the photonic integrated circuit chip. A dam structure is formed along an outer circumference of the first surface. At least part of the optical circuit is formed using a different material that is different from a material of the photonic integrated circuit chip. The resin member seals the photonic integrated circuit chip without sealing an area on an inner side with respect to the dam structure of the first surface. Second electrical wiring is formed on a surface of the resin member. The second electrical wiring is electrically connected to the first electrical wiring.

### CROSS-REFERENCE TO RELATED APPLICATION

This application is based upon and claims the benefit of priority of the prior Japanese Patent Application No. 2024-126488, filed on Aug. 2, 2024, the entire contents of which are incorporated herein by reference.

### FIELD

The embodiments discussed herein are related to an optical device and an optical transmitting-receiving module.

### BACKGROUND

In recent years, speed increase in and size reduction of optical devices that convert electric signals and optical signals are requested in long-distance optical communication or optical data communication between servers. For example, it is requested to house an optical device in a small-sized member that is referred to as a form factor that is insertable into an optical communication device. A new high-density packaging technology at the level of photonic chip referred to as CPO (Co-Packaged Optics) or chiplet has been developed. In promoting such high integration/high density, photonic integrated circuit chips represented by silicon photonics are drawing attention.

In a silicon photonics photonic integrated circuit chip, an optical modulator, an optical receiver, a multiplexer, a demultiplexer, and an optical waveguide are formed accurately and in a highly-integrated manner using a semiconductor process. Note that, with a remarkable increase in the signal transmission rate per channel, it has been difficult to further increase the modulation rate in an optical device for which a silicon material is used. For this reason, a configuration in which an optical modulator, or the like, is formed using a material enabling high-speed operations other than silicon on a silicon chip has been proposed (for example, Japanese Patent No. 6453796).

In addition to this, with an increase in the signal transmission rate, a configuration that shortens the transmission distance of an electric signal in a device is requested. For example, it is preferable to shorten the transmission distance between an optical modulator and a driver chip and the transmission distance between a light receiving element and an amplifier (TIA: Trans Impedance Amplifier) chip. From such a viewpoint, not only a conventional planar packaging structure but also a structure in which a chip is mounted in a direction perpendicular to a substrate (for example, a layered structure) has been proposed (for example, S. B. N. Gourikutty et al., 2023 IEEE 73rd Electronic Components and Technology Conference (ECTC), 207-211.).

As described above, a technique of shortening the transmission distance between an optical modulator and a driver chip and between a light receiving element and a TIA chip using a layered structure has been proposed. Note that, in the conventional technique, mold resin is formed even to the surface of the photonic integrated circuit chip. For this reason, a permittivity around an optical waveguide and wiring forming the optical element increases and there is a risk that high-speed operations will be prevented.

### SUMMARY

According to an aspect of an embodiment, an optical device includes a photonic integrated circuit chip and a resin member. The photonic integrated circuit chip has a first surface on which an optical circuit and first electrical wiring are formed. The resin member makes contact with at least part of the photonic integrated circuit chip. A dam structure is formed along an outer circumference of the first surface. At least part of the optical circuit is formed using a different material that is different from a material of the photonic integrated circuit chip. The resin member seals the photonic integrated circuit chip without sealing an area on an inner side with respect to the dam structure of the first surface. Second electrical wiring is formed on a surface of the resin member. The second electrical wiring is electrically connected to the first electrical wiring.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an optical transmitting-receiving module according to an embodiment of the disclosure;

FIG. 2 is a diagram illustrating an example of a photonic integrated circuit chip;

FIGS. 3A, 3B and 3C are a diagram (first) illustrating an example of a process of manufacturing an optical device according to the embodiment of the disclosure;

FIGS. 4A, 4B and 4C are a diagram (second) illustrating the example of the process of manufacturing an optical device according to the embodiment of the disclosure;

FIGS. 5A, 5B and 5C are a diagram (third) illustrating the example of the process of manufacturing an optical device according to the embodiment of the disclosure;

FIGS. 6A and 6B are a diagram (fourth) illustrating the example of the process of manufacturing an optical device according to the embodiment of the disclosure;

FIGS. 7A and 7B are a diagram (fifth) illustrating the example of the process of manufacturing an optical device according to the embodiment of the disclosure;

FIGS. 8A, 8B and 8C are a diagram illustrating a variation on a mold resin sealing structure including a photonic integrated circuit chip;

FIGS. 9A, 9B and 9C are a diagram illustrating a variation on the mold resin sealing structure including a photonic integrated circuit chip;

FIGS. 10A and 10B are a diagram illustrating an example of an optical transmitting-receiving module according to a second embodiment; and

FIGS. 11A and 11B are a diagram illustrating a variation on the optical transmitting-receiving module according to the second embodiment.

### DESCRIPTION OF EMBODIMENTS

### (a) First Embodiment

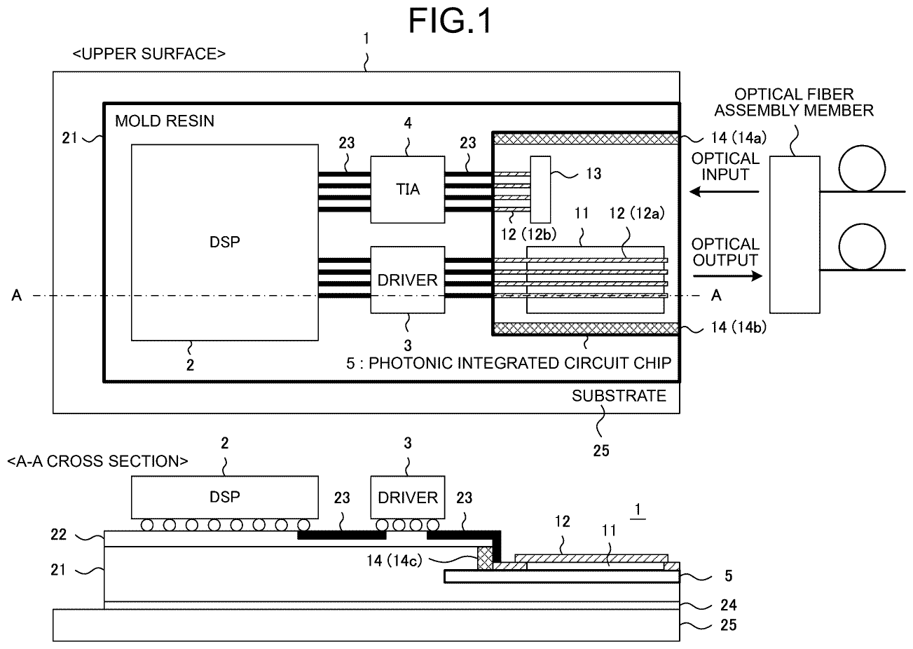

FIG. 1 is a diagram illustrating an example of an optical transmitting-receiving module according to an embodiment of the disclosure. An optical transmitting-receiving module 1 includes a digital signal processor (DSP) 2, a driver 3, an amplifier (TIA) 4, and a photonic integrated circuit chip 5. Note that the optical transmitting-receiving module 1 may further include another circuit, another element, and another function that are not illustrated in FIG. 1.

The DSP 2 is one of electric integrated circuit chips that the optical transmitting-receiving module 1 includes and the DSP 2 generates a modulation signal corresponding to a modulation system from a transmission data. The modulation signal has an amplitude of and phase information on a transmission symbol. The driver 3 is one of the electric integrated circuit chips that the optical transmitting-receiving module 1 includes and the driver 3 amplifies the modulation signal in order to drive an optical modulator. The TIA 4 is one of the electric integrated circuit chips that the optical transmitting-receiving module 1 includes and the TIA 4 amplifies a minute electric current signal that is output from the photonic integrated circuit chip 5 and outputs the amplified signal as a voltage signal. The DSP 2 performs a process of demodulating an output signal from the TIA 4. Accordingly, the DSP 2 is able to reproduce reception data based on the output signal from the TIA 4.

The photonic integrated circuit chip 5 includes an optical modulator and an optical receiver and is formed by silicon photonics. Furthermore, an optical circuit and electrical wiring are formed on a surface of the photonic integrated circuit chip 5. The optical circuit includes an optical circuit for configuring the optical modulator and an optical circuit for configuring the optical receiver. The electrical wiring includes electrical wiring that transmits a drive signal that is generated by the driver 3 and electrical wiring that transmits an output signal from the optical receiver.

The optical modulator includes an optical waveguide circuit 11 and optical element wiring 12 (12a). The optical waveguide circuit 11 includes at least one Mach-Zehnder interferometer. Continuous light that is generated by a light source (not illustrated in the drawing) is guided to the optical waveguide circuit 11. The optical element wiring 12a is formed in the vicinity of the optical waveguide to which the optical waveguide circuit 11 corresponds. A drive signal that is generated by the driver 3 is applied to the optical element wiring 12a. Thus, the continuous light that passes through the optical waveguide circuit 11 is modulated by the drive signal. Accordingly, the modulation optical signal is generated.

The optical waveguide circuit 11 forming the optical modulator is formed of a different material that is different from silicon. A material whose refractive index varies according to an electric field that is applied from the outside is used as the different material. In other words, the refractive index of the different material varies according to the external electric field. Thus, when the drive signal is applied to the optical element wiring 12a, the refractive index of the optical waveguide circuit 11 varies according to a change in the electric field resulting from the drive signal. Accordingly, a modulation optical signal corresponding to the drive signal is generated.

The optical receiver includes a photodiode 13 in this example. An optical signal that is received by the optical transmitting-receiving module 1 is guided to the photodiode 13 via an optical waveguide (not illustrated in the drawing). Accordingly, a current signal representing the received optical signal is generated. The current signal that is generated by the photodiode 13 is transmitted via the optical element wiring 12b. Note that the photodiode 13 also may be formed of a different material different from silicon.

The photonic integrated circuit chip 5 is sealed with mold resin 21. Note that an area where the optical waveguide circuit 11 and the optical element wiring 12 are formed is not sealed with the mold resin 21. In other words, even after the photonic integrated circuit chip 5 is sealed with the mold resin 21, the optical waveguide circuit 11 and the optical element wiring 12 is exposed to the air around the photonic integrated circuit chip 5. In the following description, the structure in which the photonic integrated circuit chip 5 is sealed with the mold resin 21 is sometimes referred to as “mold resin sealing structure”. The mold resin 21 is an example of a resin material that makes contact with at least part of the photonic integrated circuit chip 5.

A rewiring layer 22 is provided on a surface of the mold resin 21. Using the rewiring layer 22, mold wiring 23 is formed. The mold wiring 23 is electrically connected to the optical element wiring 12 that is formed on the photonic integrated circuit chip 5. Some of terminals of the DSP 2, the driver 3, and the TIA 4 are connected to the mold wiring 23. Note that the surroundings of solder bumps may be sealed with an underfill, or the like, from a viewpoint of reliability.

The mold resin sealing structure is fixed to a substrate 25 using a die attachment agent 24, or the like. A low-speed electric signal line, a power line, and a control line, for example, may be realized by wire bonding, or the like. In this case, a wire electrically connects the mold resin sealing structure and the substrate 25. In order to shorten the length of the wire, gliding or polishing processing may be performed on a back surface of the mold resin sealing structure to thin the mold resin 21. Note that, in FIG. 1, the wire is omitted in order to make the drawing to be viewed easily.

A dam structure 14 is formed near the outer circumference of the surface of the photonic integrated circuit chip 5 (a parts-mounted surface on which the optical waveguide circuit 11 and the optical element wiring 12 are formed). The shape of the photonic integrated circuit chip 5 is rectangular. In an example, the dam structure 14 is formed near three of the four sides forming the outer circumference of the parts-mounted surface of the photonic integrated circuit chip 5. In another mode, the dam structure may be formed for all the four sides. Note that the top view illustrates dam structures 14a and 14b that are formed along a side on the upper side of the photonic integrated circuit chip 5 and a side on the lower side. The cross-sectional view illustrates a dam structure 14c that is formed along a side on the side where the driver 3 is provided.

The dam structure 14 is provided such that the mold resin 21 does not reach the parts-mounted surface of the photonic integrated circuit chip 5 in a process of sealing the photonic integrated circuit chip 5. Thus, the different material mounted on the photonic integrated circuit chip 5 is exposed to the air. In other words, the different material makes contact with a substance (the air herein) having a relative permittivity lower than that of resin. When the different material that is used in the photonic integrated circuit chip 5 (for example, lithium niobate that is used in a LN modulator) is used in a state of making contact with a substance having a low relative permittivity (the air herein), the response speed increases.

Accordingly, according to the embodiment of the disclosure, speed increase in the optical device is realized. In addition to this, electrically connecting devices with the shortest electrical wiring (that is, the mold wiring 23) on the mold resin 21 makes it possible to reduce a transmission loss of a high-speed signal.

Note that an optical fiber assembly member is attached to the optical transmitting-receiving module 1. Accurate optical axis alignment is performed on an input/output unit of the photonic integrated circuit chip 5 and the optical fiber assembly member is fixed using a transparent adhesive, or the like.

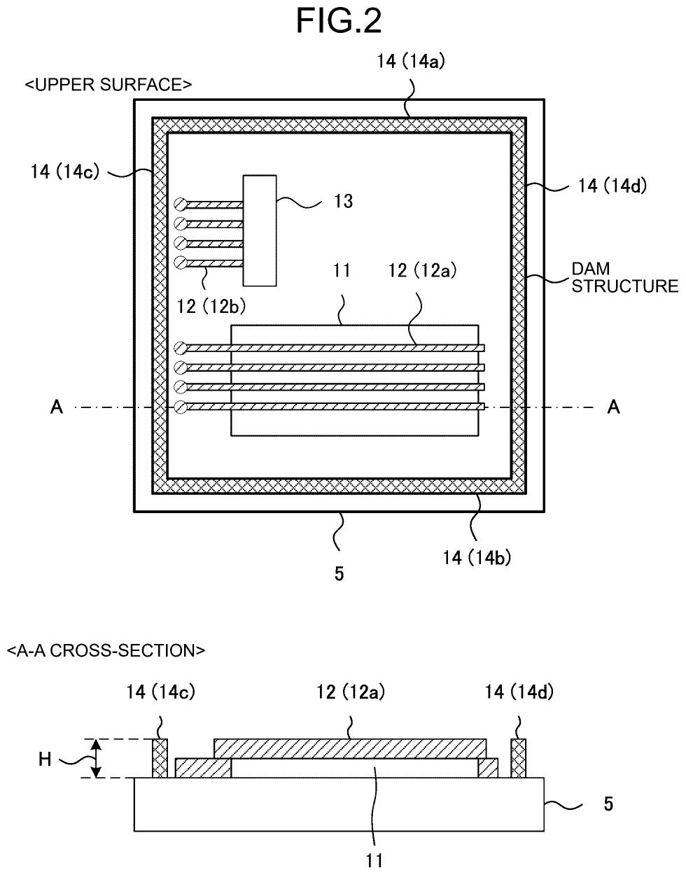

FIG. 2 illustrates an example of the photonic integrated circuit chip 5. As described above, the photonic integrated circuit chip 5 includes a photo modulator and an optical receiver. The optical modulator includes the optical waveguide circuit 11 and the optical element wiring 12a and the optical receiver includes the photodiode 13.

The photonic integrated circuit chip 5 is formed on a silicon wafer. In a wafer process, such as silicon photonics, the optical waveguide and part of an optical element are formed. In order to realize high-speed operations, the different material different from silicon is formed (or attached) in a given position. For example, oxide ferroelectric, such as lithium niobate, lanthanum modified lead zirconate titanate, or barium titanate, or a compound semiconductor, such as indium phosphide or gallium arsenide, is usable as the different material. The different material, for example, may be formed by a thin-film transfer process, such as micro transfer printing. In this example, for example, at least part of the optical waveguide circuit 11 forming the optical modulator is formed of a different material.

Furthermore, the optical element wiring 12 is formed on the surface of the photonic integrated circuit chip 5. The optical element wiring 12 includes a conductive pattern (the optical element wiring 12a) that transmits the drive signal output from the driver 3 illustrated in FIG. 1. The optical element wiring 12 includes a conductive pattern (the optical element wiring 12b) that transmits the current signal generated by the photodiode 13.

The dam structure 14 (14a to 14d) is formed on the surface of the photonic integrated circuit chip 5. The dam structure 14 is formed along an outer circumference of the photonic integrated circuit chip 5 on the parts-mounted surface on which the optical waveguide circuit 11, the optical element wiring 12, and the photodiode 13 are formed. The dam structure 14 is formed such that the dam structure 14 surrounds the optical waveguide circuit 11, the optical element wiring 12, and the photodiode 13. A height H of the dam structure 14 is equal to or larger than that of a protruding structure that is formed on the surface of the photonic integrated circuit chip 5. In other words, the height of the dam structure 14 with respect to the surface of the photonic integrated circuit chip 5 is equal to or larger than that of the protruding structure formed on the surface of the photonic integrated circuit chip 5. The protruding structure formed on the photonic integrated circuit chip 5 consists of the optical waveguide circuit 11 and the optical element wiring 12. Alternatively, the protruding structure consists of the photodiode 13.

The dam structure 14 may be formed by the same process as that for the optical element wiring 12 or may be formed by another process. For example, the dam structure 14 is realized using plating having a thickness of approximately 10 μm. In this case, the dam structure 14 may be formed using plating of Au or Cu. The photonic integrated circuit chip 5 on which the dam structure 14 is formed is cut out of the wafer by dicing, or the like.

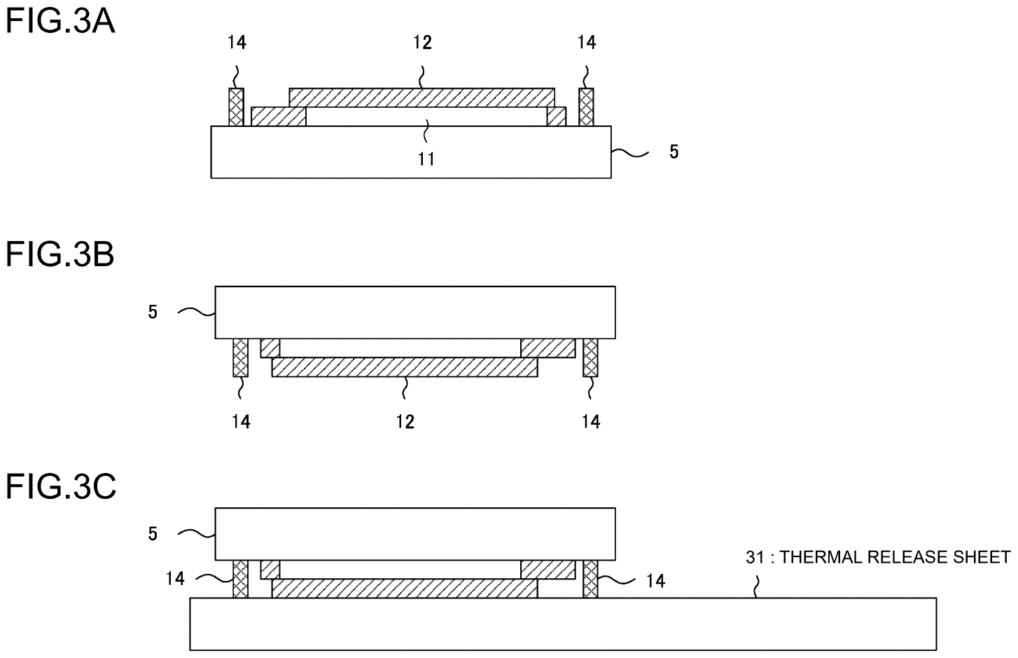

FIGS. 3A to 7B illustrate an example of a process of manufacturing an optical device according to the embodiment of the disclosure. Here, the photonic integrated circuit chip 5 illustrated in FIG. 2 is formed on a wafer and is cut out of the wafer by dicing, or the like. In other words, the photonic integrated circuit chip 5 is prepared as illustrated in FIG. 3A.

As illustrated in FIGS. 3B and 3C, in a state of being flipped vertically, the photonic integrated circuit chip 5 is pressed onto and fixed to a thermal release sheet 31. A parts-mounted surface of the photonic integrated circuit chip 5 (the surface on which the optical waveguide circuit 11, the optical element wiring 12, and the photodiode 13 are formed) is pressed against the thermal release sheet 31. Note that the dam structure 14 is formed on the parts-mounted surface of the photonic integrated circuit chip 5. Thus, the photonic integrated circuit chip 5 is fixed to the thermal release sheet 31 actually such that the dam structure 14 is pressed against the thermal release sheet 31.

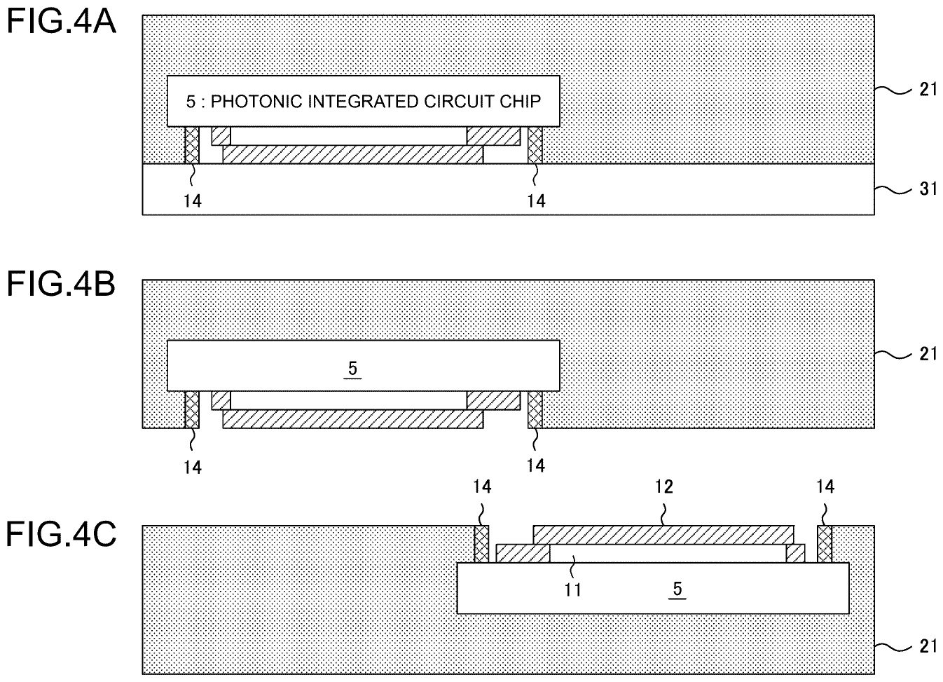

In a state of being fixed to the thermal release sheet 31, the photonic integrated circuit chip 5 is housed into a mold in a given shape. A specified amount of the mold resin 21 is poured into the mold and is heated and molded. Accordingly, as illustrated in FIG. 4A, the photonic integrated circuit chip 5 is sealed with the mold resin 21. Note that, because the dam structure 14 is formed on the parts-mounted surface of the photonic integrated circuit chip 5, an area on the inner side with respect to the dam structure 14 is not filled with the mold resin 21.

After the mold resin 21 cures, as illustrated in FIGS. 4B and 4C, the thermal release sheet 31 is released. Here, the area on the inner side with respect to the dam structure 14 is not filled with the mold resin 21. Accordingly, the optical waveguide circuit 11, the optical element wiring 12, and the photodiode 13 are not sealed with the mold resin 21. In other words, the different material that is provided on the parts-mounted surface of the photonic integrated circuit chip 5 is exposed to the air.

Subsequently, mold wiring is formed on the mold resin sealing structure. The mold wiring is, for example, formed by a semiconductor manufacturing process. The specific process is as follows.

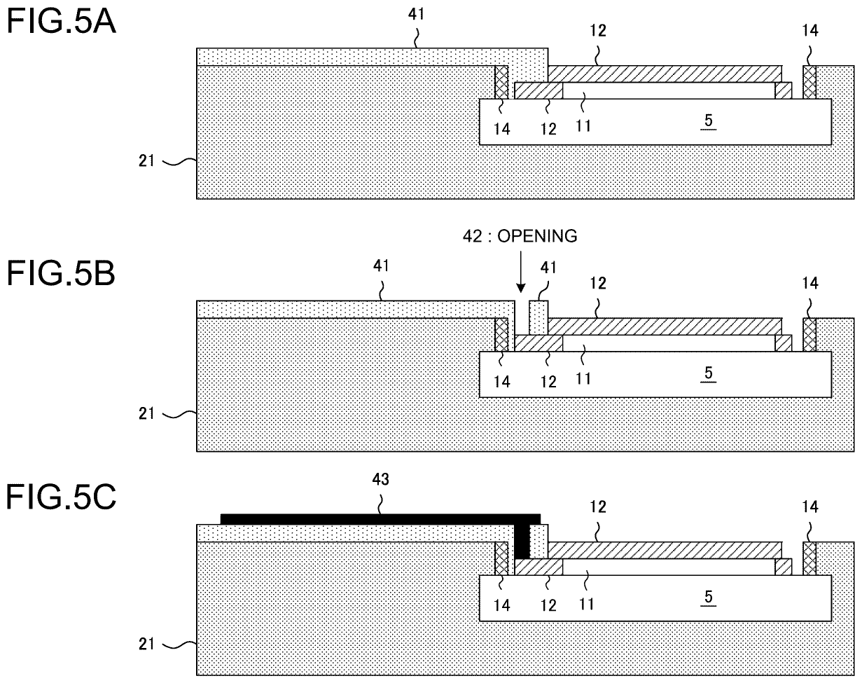

As illustrated in FIG. 5A, an insulating layer 41 us formed on an upper surface of the mold resin 21. The insulating layer 41 is formed to an end of the photonic integrated circuit chip 5. Specifically, the insulating layer 41 is formed to an upper side with respect to the optical element wiring 12. The insulating layer 41, for example, is realized using photosensitive resin. In this case, after surface processing is performed, the insulating layer 41 is formed on only a needed area by application of spin coating and an exposure development process. Subsequently, as illustrated in FIG. 5B, an opening 42 is formed in a given position in the insulating layer 41. The opening 42, for example, is formed on a pad of any one or both of the optical element wiring 12 and the control line that are provided on the photonic integrated circuit chip 5.

As illustrated in FIG. 5C, an electrical wiring layer 43 of the mold wiring is formed. The electrical wiring layer 43 is formed on the insulating layer 41 by plating. Specifically, first of all, a seed layer is formed on an upper surface of the insulating layer 41 and the opening 42. The seed layer, for example, is realized by a thin film of Cu/Ti, or the like. A resist opening pattern for forming the electrical wiring layer is formed. In other words, Cu pattern plating is performed by conduction through the seed layer in a plating bath and thereafter Cu wiring in a needed form is obtained by resist stripping and wet etching on the seed layer. Accordingly, the electrical wiring layer 43 is formed. The electrical wiring layer 43 is electrically connected to the optical element wiring 12 as illustrated in FIG. 5C.

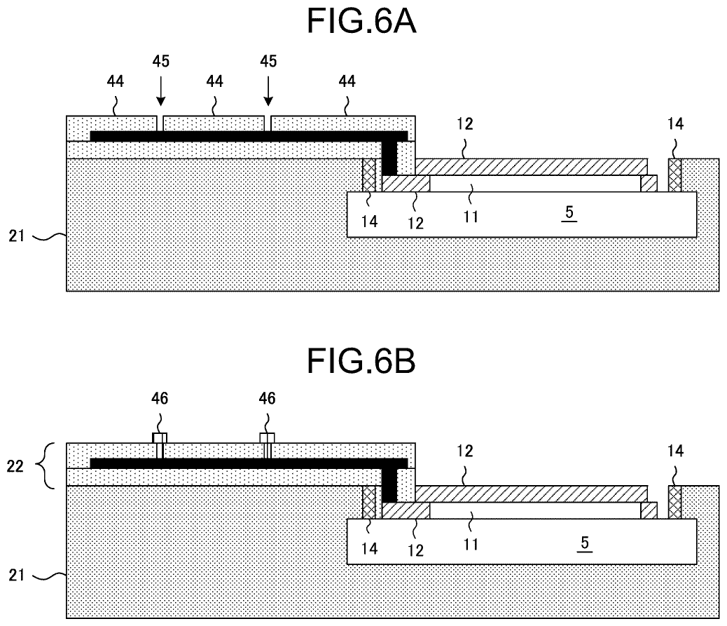

As illustrated in FIG. 6A, an insulating layer 44 is formed on the electrical wiring layer 43. A method of forming the insulating layer 44 may be the same method as that by which the insulating layer 41 illustrated in FIGS. 5A to 5C is formed. It is possible to further form mold wiring on an upper surface of the insulating layer 44. A method of forming the mold wiring on the upper surface of the insulating layer may be the same as the method by which the electrical wiring layer 43 illustrated in FIGS. 5A to 5C is formed. In this example, openings 45 are formed in given positions as illustrated in FIG. 6A. Each of the openings 45 is used as a via as illustrated in FIG. 6B. Pads 46 that are connected to the respective vias are formed. It is preferable that the surfaces of the pads 46 be plated using Ni, or the like, such that the surface meets connection with solder bumps.

The insulating layer 41, the electrical wiring layer 43, the insulating layer 44, and the pads 46 form the rewiring layer that corresponds to the rewiring layer 22 and the mold wiring 23 illustrated in FIG. 1. Note that, in the example, the rewiring layer is a double-layered structure; however, a multi-layered structure of three or more layers. The respective pads 46, for example, can make direct contact with terminals corresponding to the DSP 2, the driver 3, and the TIA 4 illustrated in FIG. 1.

In a mold resin sealing process, a positional shift sometimes occurs between an electric connection terminal on the substrate (the substrate 25 illustrated in FIG. 1) and an electric connection terminal at an end of the optical element wiring formed on the photonic integrated circuit chip 5. When the positional gap is large, in order to absorb the positional shift, it is preferable to, when forming a mold wiring layer, scale up or down and rotate a pattern and layer the pattern using a direct imaging exposure device such that electric connection is enabled.

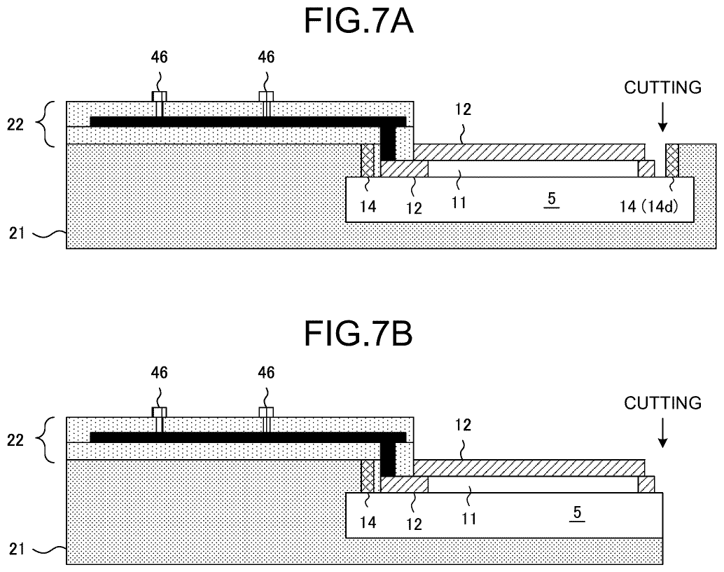

Thereafter, as illustrated in FIG. 7A, grinding is performed on a back surface of the mold resin sealing structure and accordingly the device is thinned. In other words, part of the mold resin 21 is removed. Furthermore, as illustrated in FIG. 7B, an ed of the photonic integrated circuit chip 5 is cut out. The dam structure 14 is cut out partly. Specifically, the dam structure 14 that is formed on the side where an optical input or an optical output is made illustrated in FIG. 1 is cut out. In the example illustrated in FIG. 2, the dam structure 14d is cut out. Furthermore, optical end face polishing is performed.

After the above-described processing, the mold resin sealing structure is mounted on another substrate with a die attachment agent using a die bonder. In other words, as illustrated in FIG. 1, the mold resin sealing structure is fixed to the substrate 25 using the die attachment agent 24. Electrical wiring for connecting to the corresponding conductive pattern on the substrate 25 is provided by wire bonding. Furthermore, optical axis alignment between an optical input output unit consisting of the optical waveguide on the photonic integrated circuit chip 5 and the optical fiber assembly member illustrated in FIG. 1 is performed. The optical fiber assembly member is fixed using a transparent adhesive. Accordingly, the optical device according to the embodiment of the disclosure is configured.

According to the embodiment of the disclosure, mounting the different material in which a change in the refractive index occurs efficiently according to the external electric field on the photonic integrated circuit chip 5 that is sealed with the mold resin 21 realizes high-speed operations. The dam structure 14 is formed along the outer circumference of the photonic integrated circuit chip 5 and thus, in the mold resin sealing process, the mold resin is inhibited from entering the parts-mounted surface of the photonic integrated circuit chip 5. It is thus possible to expose the parts-mounted surface of the photonic integrated circuit chip 5 to the air and accordingly the surroundings of the optical modulator are a medium (that is, the air) having a low permittivity and further speed increase in the optical modulator is realized. Additionally, using the mold wiring layer that is formed on the upper surface of the mold resin 21, the electric terminal (the pad 46) for connecting to the electric integrated circuit chip (the DSP 2, the driver 3, and the TIA 4) is formed. The signal line that transmits a high-speed signal between the photonic integrated circuit chip 5 and the electric integrated circuit chip is short. Accordingly, size reduction of and speed increase in the optical transmitting-receiving module 1 is realized.

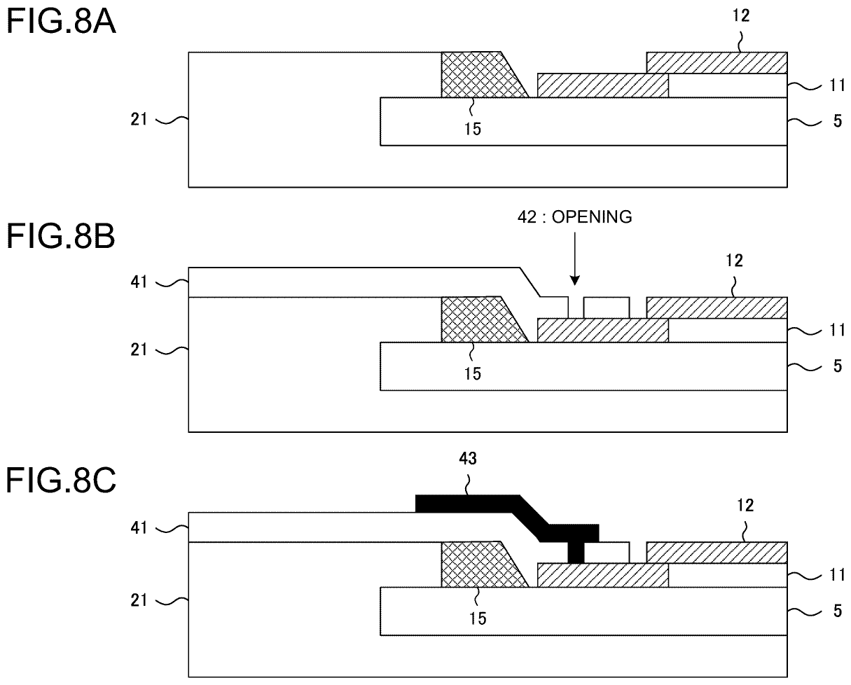

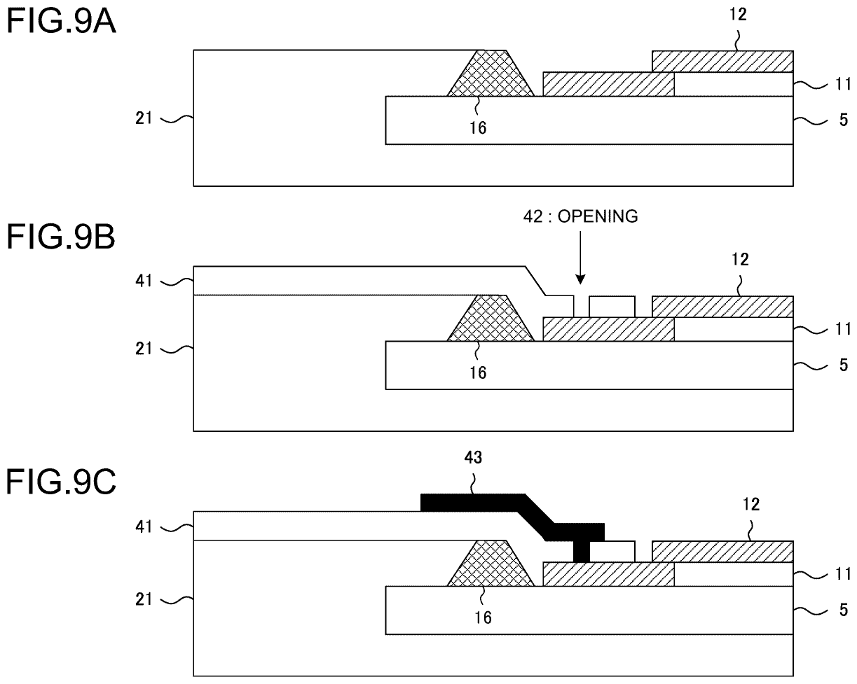

FIGS. 8A to 8C, and 9A to 9C illustrate variations on the mold resin sealing structure including the photonic integrated circuit chip 5. Note that FIGS. 8A to 8C, and 9A to 9C illustrates a partial cross-section of the mold resin sealing structure.

In the embodiment illustrated in FIGS. 2 to 7B, the shape of the cross-section of the dam structure is rectangular. Note that the shape of the cross-section of the dam structure 14 is not limited to rectangular. In the variations illustrated in FIGS. 8A to 8C, and 9A to 9C, the shape of the cross-section of the dam structure is differ from that of the embodiment illustrated in FIGS. 2 to 7.

In the variation illustrated in FIGS. 8A to 8C, a cross-section of a dam structure 15 is tapered. Specifically, a cross-section of the dam structure 15 has a shape having a width that is larger on a lower wide (or a bottom side) than on an upper side (or a ceiling side). The cross-section of the dam structure 15 is tapered on a side surface on a side facing the inner side of the parts-mounted surface of the photonic integrated circuit chip 5. In other words, as illustrated in FIG. 8A, the dam structure 15 is tapered on the side where the optical elements (the optical waveguide circuit 11, the optical element wiring 12, and the photodiode 13) are formed on the photonic integrated circuit chip 5.

The dam structure 15, for example, is formed by exposing photosensitive polymer in stages. Note that the material of the dam structure 15 is not limited to polymer. In other words, the dam structure 15 may be formed by pattern plating or another dam structure member may be adhered in addition to the dam structure 14 illustrated in FIG. 2.

There is a step between the upper surface of the mold resin 21 and the surface of the photonic integrated circuit chip 5. For this reason, when the side surface of the dam structure is perpendicular to the surface of the photonic integrated circuit chip 5, there is a risk that the insulating layer 41 will be thin at a corner of the dam structure 14 as illustrated in FIGS. 5A to 5C. In this case, there is a risk that sufficient insulation will not be realized at the corner of the dam structure 14 (the upper right corner of the dam structure 14 in FIGS. 5A to 5C).

On the other hand, the cross-section of the dam structure 15 is tapered and the corner is obtuse as illustrated in FIGS. 8A to 8C. For this reason, the insulating layer 41 is not thin at the corner of the dam structure 15 and it is possible to cover the area from the upper surface of the mold resin 21 to the surface of the photonic integrated circuit chip 5 without exposure. Additionally, because the insulating layer 41 is formed gently from the upper surface of the mold resin 21 to the surface of the photonic integrated circuit chip 5 and thus a resist for patterning can be applied appropriately in the process of forming the electrical wiring layer 43 on the insulating layer 41, a risk of disconnection in the electrical wiring layer 43 around the interface between the mold resin 21 and the photonic integrated circuit chip 5 lowers as illustrated in FIG. 8C.

In the variation illustrated in FIGS. 9A to 9C, a dam structure 16 is formed of droplets. For this reason, a cross section of the dam structure 16 is tapered on both a side surface facing the inner side of the photonic integrated circuit chip 5 and a side surface facing the outer side of the photonic integrated circuit chip 5. Accordingly, even with the structure illustrate in FIGS. 9A to 9C, the same effect as that illustrated in FIGS. 8A to 8C is obtained.

The dam structure 16, for example, is formed by applying resin in droplets along the outer circumference of the surface of the photonic integrated circuit chip 5. In this case, the resin for forming the dam structure 16 is, for example, epoxy resin or polyimide resin.

### (b) Second Embodiment

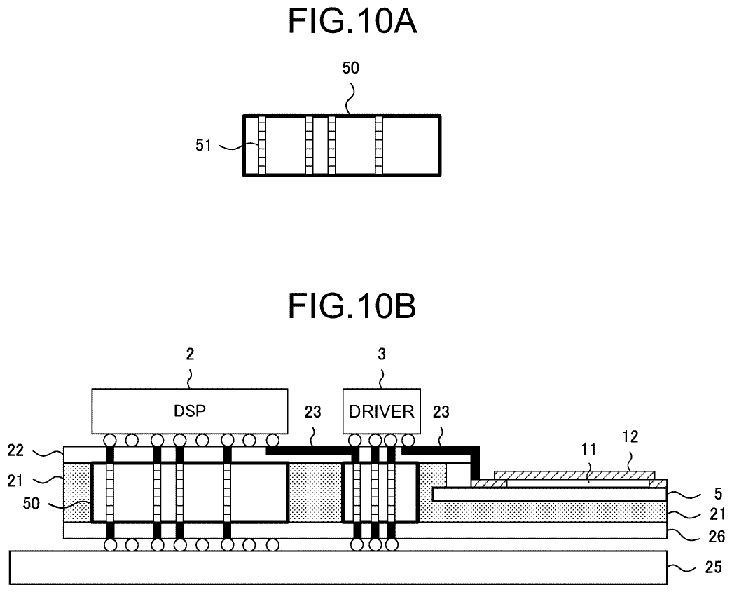

FIGS. 10A and 10B are a diagram illustrating an example of an optical transmitting-receiving module according to a second embodiment of the disclosure. In the second embodiment, an auxiliary circuit board is embedded in mold resin, or the like.

In an auxiliary circuit board 50, at least one via is formed as illustrated in FIG. 10A. A conductive pattern and pads are formed on each of an upper surface and a lower surface of the auxiliary circuit board 50. Each of the vias electrically connects the conductive pattern that is formed on the upper surface of the auxiliary circuit board 50 and the conductive pattern that is formed on the lower surface. The auxiliary circuit board 50 is realized, for example, using an organic substrate or a ceramics substrate. The auxiliary circuit board 50 may be a silicon substrate or a glass substrate in which a through-hole via is formed. The auxiliary circuit board 50 is sealed with the mold resin 21. Specifically, the photonic integrated circuit chip 5 and the auxiliary circuit board 50 are sealed with the mold resin 21 in the same process.

In a mold resin sealing structure in which the photonic integrated circuit chip 5 and the auxiliary circuit board 50 are sealed is mounted on the upper surface of the substrate 25 as illustrated in FIG. 10B. The rewiring layer 22 is formed on an upper surface of the mold resin sealing structure. An electric integrated circuit chip (the DSP 2, the driver 3, and the TIA 4) is mounted on an upper side of the rewiring layer 22. A rewiring layer 26 is formed on the upper surface of the mold resin sealing structure. The rewiring layer 26 is able to provide connection to a conductive pattern that is formed on the substrate 25. A given terminal of the electric integrated circuit chip is electrically connected to the corresponding conductive pattern that is formed on the substrate 25 via the via 51 of the auxiliary circuit board 50.

Note that, in the example illustrated in FIGS. 10A and 10B, the auxiliary circuit board 50 is provided for each electric integrated circuit chip; however, the second embodiment is not limited this configuration. In other words, a configuration in which the single auxiliary circuit board 50 is provided for a plurality of electric integrated circuits may be used.

According to the second embodiment, it is possible to realize connection between each electric integrated circuit chip and the circuit on the substrate 25 not by wire bonding but using a ball grid array (BGA), a Cu pillar, or the like. Thus, this configuration contributes to size reduction of the substrate 25 and the optical transmitting-receiving module 1. In addition to this, connection using small vias with smaller inductance components than that of wires is realized and accordingly a loss in a high-frequency signal line is inhibited and an increase in impedance in a power line is inhibited.

Note that it is possible to use the terminals (for example, the pads or the under bump metal (UBM)) of the auxiliary circuit board 50 without change on the side of the upper surface of the mold resin sealing structure. On the side of a lower surface of the mold resin sealing structure, terminals for connection to a lower substrate, such as Cu pillars, may be formed by a mold wiring process.

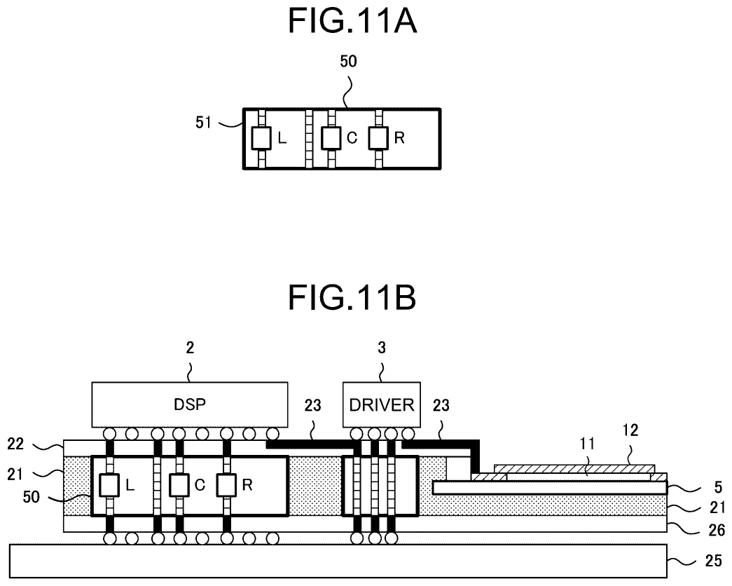

FIGS. 11A and 11B illustrate a variation on the optical transmitting-receiving module according to the second embodiment. In this example, one or a plurality of circuit elements are provided for the vias 51 in the auxiliary circuit board 50. Specifically, as illustrated in FIG. 11A, any one, some, or all of a capacitor C, an inductor L, and a resistor R are formed in the auxiliary circuit board 50. As illustrated in FIG. 11B, the auxiliary circuit board 50 on which any one, some, or all of the capacitor C, the inductor L, and the resistor R are formed is sealed with the mold resin 21.

The capacitor C, for example, is realized by forming a capacity between layers of the auxiliary circuit board 50 or the wiring layer on the surface. In this case, the capacity may be formed using a ferroelectric material. The inductor L is realized using a rectangular spiral coil structure. The resistor R may be realized by arranging a material with a high resistivity in the layer of the auxiliary circuit board 50.

According to the configuration illustrated in FIGS. 11A and 11B, it is possible to make a packaging structure dense without using a chip member. Forming the capacitor C in the substrate gives a large capacity component to the power wiring and thus it is possible to reduce a power impedance. Introducing the inductor L to part of the signal line makes it possible to reduce a transmission loss caused by occurrence of a peak at a specific frequency as a result of occurrence of resonance in the signal line. The resistor R is able to function as a damping resistor that controls resonance of the signal line and resonance resulting from the power impedance.

According to the mode described above, it is possible to realize both size reduction and speed increase of an optical device.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical device comprising:
a photonic integrated circuit chip having a first surface on which an optical circuit and first electrical wiring are formed; and
a resin member that makes contact with at least part of the photonic integrated circuit chip,
wherein a dam structure is formed along an outer circumference of the first surface,
at least part of the optical circuit is formed using a different material that is different from a material of the photonic integrated circuit chip,
the resin member seals the photonic integrated circuit chip without sealing an area on an inner side with respect to the dam structure of the first surface,
second electrical wiring is formed on a surface of the resin member, and
the second electrical wiring is electrically connected to the first electrical wiring.

2. The optical device according to claim 1, wherein the dam structure has a height with respect to the first surface, which is a height equal to or higher than heights of the optical circuit and the first electrical wiring.

3. The optical device according to claim 1, wherein the first surface is rectangular, and
the dam structure is formed near at least three of four sides forming an outer circumference of the first surface.

4. The optical device according to claim 1, wherein the different material has a refractive index that varies according to an external electric field.

5. The optical device according to claim 4, wherein the optical circuit includes an optical waveguide circuit that is formed of the different material,
at least part of the first electrical wiring is formed near the optical waveguide circuit, and
the optical waveguide circuit and at least part of the first electrical wiring formed near the optical waveguide circuit form an optical modulator.

6. The optical device according to claim 1, wherein the dam structure has a cross-section that is tapered on a side surface on a side facing an inner side of the first surface.

7. The optical device according to claim 1, wherein the second electrical wiring includes a pad for being electrically connected to a terminal of an electric integrated circuit chip.

8. The optical device according to claim 1, wherein the second electrical wiring is formed on a first surface of the resin member,
third electrical wiring is formed on a second surface of the resin member,
an auxiliary circuit board in which a via is formed is embedded in the resin member, and
the second electrical wiring and the third electrical wiring are electrically connected via the via.

9. The optical device according to claim 8, wherein a capacitor, an inductor, or a resistor are electrically connected to the via in the auxiliary circuit board.

10. An optical transmitting-receiving module comprising:
a photonic integrated circuit chip having a first surface on which an optical circuit for configuring an optical modulator and an optical receiver and first electrical wiring are formed;
a resin member that makes contact with at least part of the photonic integrated circuit chip;
a driver chip that drives the optical modulator;
an amplifier chip that amplifies an output signal of the optical receiver; and
a digital signal processor chip that controls the driver chip and that processes an output signal of the amplifier chip,
wherein a dam structure is formed along an outer circumference of the first surface,
at least part of the optical circuit is formed using a different material that is different from a material of the photonic integrated circuit chip,
the resin member seals the photonic integrated circuit chip without sealing an area on an inner side with respect to the dam structure of the first surface,
second electrical wiring is formed on a surface of the resin member,
each of a terminal of the driver chip, a terminal of the amplifier chip, and a terminal of the digital signal processor chip is connected electrically to the second electrical wiring on the resin member, and
the second electrical wiring is connected electrically to the first electrical wiring.
